(19) United States
(12) Patent Application Publication
(10) Pub. No.: US 2013/0152416 A1
(43) Pub. Date: Jun. 20, 2013

(54) MEASURING DEVICE

(71) Applicants: WEN-MING YI, Wuhan City (CN); CONG-XU HU, Wuhan City (CN); XIAO-LI LIU, Wuhan City (CN); YU-LIN LIU, Wuhan City (CN)

(72) Inventors: WEN-MING YI, Wuhan City (CN); CONG-XU HU, Wuhan City (CN); XIAO-LI LIU, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/572,778

(22) Filed: Aug. 13, 2012

(30) Foreign Application Priority Data
Dec. 15, 2011 (CN) 201110420310.5

(51) Int. Cl. B43L 7/10

(52) U.S. Cl. 33/464

(57) ABSTRACT

A measuring device includes a bracket and a sliding ruler. The bracket includes a base and a first side plate. The sliding ruler is slidably attached to the bracket and includes a top wall and a first sidewall. The first side plate includes a first top surface, a first set of scale lines, and first scale values marking the first set of scale lines. The first scale values increase incrementally from the base to a scale value N at the first top surface. A distance between the first top surface and a bottom surface of the base is equal to the scale value N. The first sidewall includes second set of scale lines, and second scale values marking the second set of scale lines. The second scale values decrease incrementally from the base to the scale value N at the top wall.

### BACKGROUND

1. Technical Field

The present disclosure relates to measuring devices, and particularly to a height measuring device.

2. Description of Related Art

In tests, such as a noise power test, a plurality of microphones are placed at different heights from the ground. In an audio laboratory, a ruler is used to measure the different heights. However, when a required height is higher than a range of the ruler, one more ruler is needed, which is inconvenient. Therefore, an improved measuring device may be desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a measuring device.

FIG. 2 is an assembled, isometric view of the measuring device of FIG. 1.

FIG. 3 is similar to FIG. 2, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

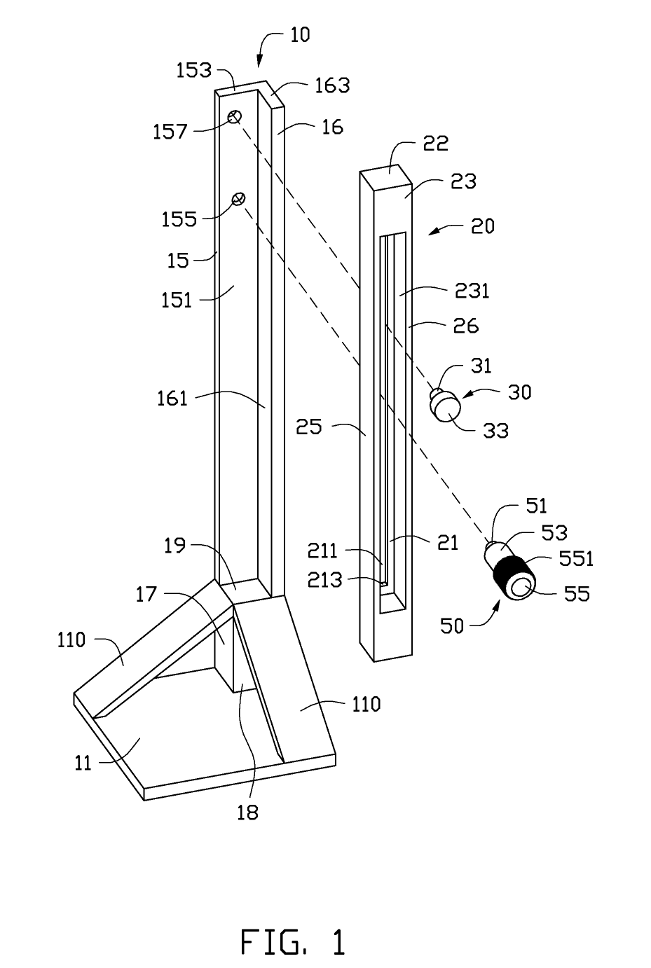

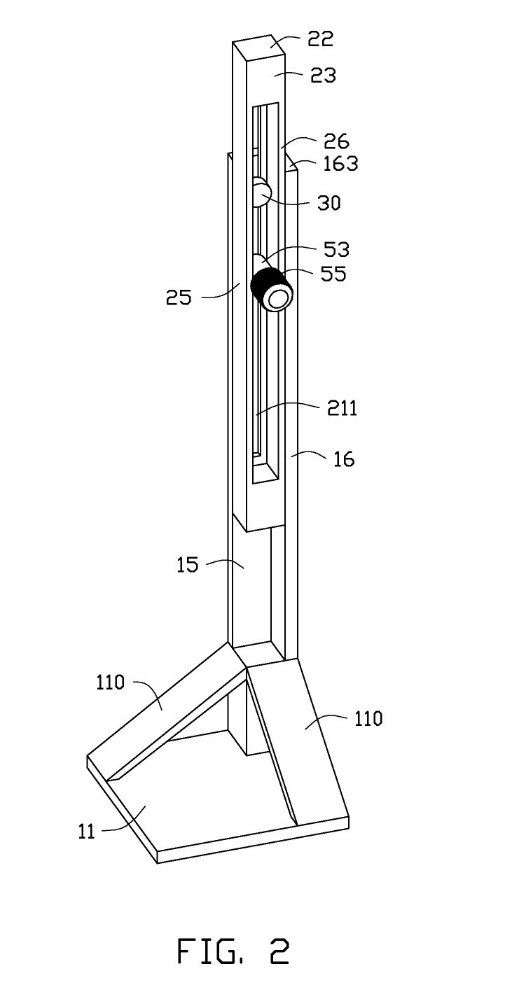

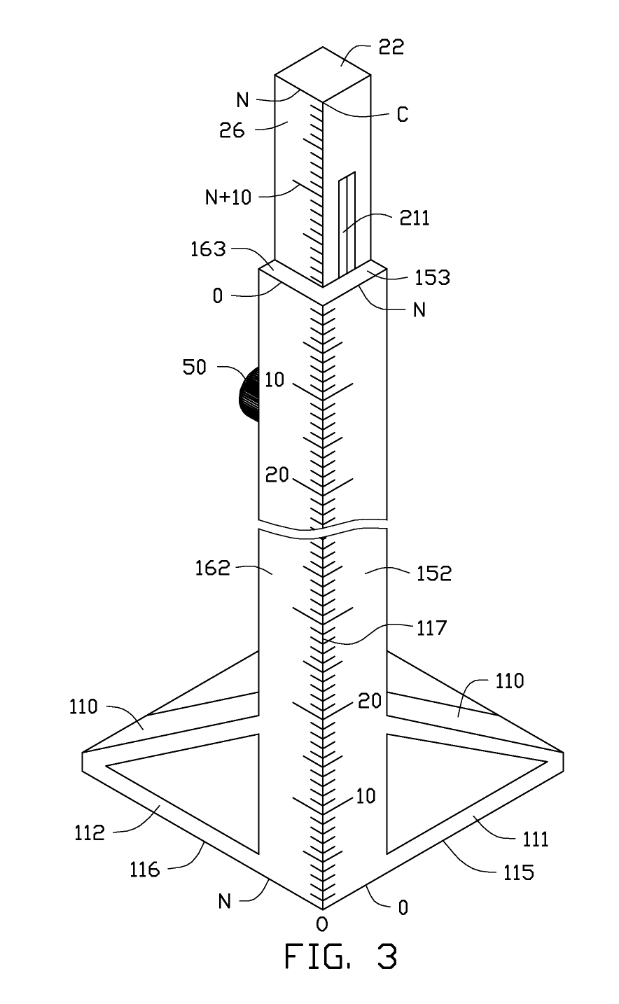

FIGS. 1-3 show a measuring device in accordance with an embodiment. The measuring device includes a bracket 10, a sliding ruler 20, a limiting member 30, and a mounting member 50.

The bracket 10 includes a base 11, a first side plate 15, and a second side plate 16 intersecting with the first side plate 15. In one embodiment, the base 11 is substantially parallel to the first side plate 15 and the second side plate 16, and the first side plate 15 is substantially perpendicular to the second side plate 16.

The base 11 includes a first side surface 111 and a second side surface 112. In one embodiment, the first side surface 111 is substantially perpendicular to the second side surface 112. The first side plate 15 includes a first top surface 153, a first inner surface 151, and a first outer surface 152 opposite to the first inner surface 151. In one embodiment, the first inner surface 151 is substantially parallel to the first outer surface 152, and the first inner surface 151 and the first outer surface 152 are substantially perpendicular to the first top surface 153. The first side plate 15 defines a locking hole 155 and an installation hole 157. The second side plate 16 includes a second top surface 163, a second inner surface 161, and a second outer surface 162 opposite to the second inner surface 161. In one embodiment, the second inner surface 161 is substantially parallel to the second outer surface 162, the second inner surface 161 and the second outer surface 162 are substantially perpendicular to the second top surface 163, and the first top surface 153 and the second top surface 163 are substantially parallel to a top surface and a bottom surface of the base 11. A first support plate 17 and a second support plate 18 extend perpendicularly from the top surface of the base 11. The first support plate 17 is substantially perpendicular to the second support plate 18 and the first side plate 15. The second support plate 18 is substantially perpendicular to the second side plate 16. A top plate 19 is substantially perpendicularly connected to the first support plate 17, the second support plate 18, the first side plate 15, and the second side plate 16. The top plate 19 is substantially perpendicular to the top surface of the base 11. Two support boards 110 extend obliquely from the base 11 and are connected to the first support plate 17 and the second support plate 18. The two support boards 110, the first support plate 17, and the second support plate 18 strengthen the base 11, so that the base 11 is positioned more stably on a test surface. In one embodiment, the base 11 is rectangular.

The first outer surface 152 is coplanar with the first side surface 111. The bottom surface of the base 11 intersects the first side surface 111 at a first edge 115. The second outer surface 162 is coplanar with the second side surface 112. The bottom surface of the base 11 intersects the second side surface 112 at a second edge 116. The first outer surface 152 intersects the second outer surface 162 at a third edge 117. The first edge 115, the second edge 116, and the third edge 117 intersect at a first point O. A first set of scale lines are marked on the first outer surface 152. The first set of scale lines includes a plurality of first scale values. The first point O is point zero or an origin of the first set of scale lines. The plurality of first scale values increases gradually from bottom to top. A second set of scale lines is marked on the second outer surface 162. The second set of scale lines includes a plurality of second scale values. The first point 0 is an origin of the second set of scale lines. The plurality of second scale values decreases gradually from bottom to top. A largest value of the first scale value is the same as the largest value of the second scale value, and this value is N. A distance between each of the first top surface 153 and the second top surface 163 and the bottom surface of the base 11 is N.

The sliding ruler 20 includes a rear wall 21, a top wall 22, a front wall 23 opposite to the rear wall 21, a first sidewall 25, and a second sidewall 26 opposite to the first sidewall 25. The top wall 22, the rear wall 21, and the second sidewall 26 intersect at a second point C. The rear wall 21 defines a sliding slot 211. The sliding slot 211 includes a limiting end 213 opposite to the top wall 22. The front wall 23 defines an opening 231. In one embodiment, the opening 231 is rectangular. A third set of scale lines is marked on the second sidewall 26. The third set of scale lines includes a plurality of third scale values. The second point C is an origin of the third set of scale lines. A scale value corresponding to the second point C is N. The plurality of third scale values increases gradually from the top wall 22 to the bottom.

The limiting member 30 includes a limiting portion 31 and a blocking portion 33. In one embodiment, a cross-section of each of the limiting portion 31 and the blocking portion 33 is circular. A diameter of the limiting portion 31 is smaller than a width of the sliding slot 211. A diameter of the blocking portion 33 is greater than the width of the sliding slot.

The mounting member 50 includes a locking portion 51, a first mounting portion 53, and a second mounting portion 55. In one embodiment, a cross-section of each of the locking portion 51, the first mounting portion 53, and the second mounting portion 55 is circular. A diameter of the first mounting portion is greater than a diameter of the locking portion 51. A diameter of the second mounting portion 55 is greater than the width of the sliding slot 211. A diameter of the first mounting portion 53 is greater than the width of the sliding slot 211 and smaller than a width of the opening 231. The diameter of the second mounting portion 55 is greater than the width of the opening 231. A high-friction portion (antiskid portion 551) is located on an outer surface of the second mounting portion 55.

In assembly, the sliding ruler 20 is positioned on the top plate 19. The top wall 22 is coplanar with the first top surface 153 and the second top surface 163. The limiting portion 31 is engaged in the installation hole 157 through the sliding slot 211. The limiting portion 31 is slidable along the sliding slot 211 relative to the sliding ruler 20. The locking portion 51 is removably engaged in the locking hole through the sliding slot 211. The first mounting portion 53 abuts an inner surface of the rear wall 21. The second mounting portion 55 abuts the front wall 23. The mounting member 50 engages the sliding ruler 20 to the bracket 10.

In use, the base 11 of the bracket 10 is placed on a flat surface. The measuring device can assume a plurality of positions, having different pre-set distances from the ground. When the different pre-set distances are not more than the scale value N, the first set of scale lines and the second set of scale lines of the bracket 10 are sufficient to measure or confirm the different pre-set distances and determine the plurality of positions. When the different pre-set distances are greater than the scale value N, the mounting member 50 is rotated away from the first side plate 15. The sliding ruler is pulled upwards, until the third scale value is equal to each pre-set distance. The mounting member is rotated towards the first side plate 15, to engage the sliding ruler 20 to the bracket 10. Thus, a distance between the top wall 22 and the test surface is equal to the pre-set distance and the relevant height can thus be determined or confirmed.

When the sliding ruler 20 is slid upwards, the limiting end 213 abuts the limiting portion 31, to prevent the sliding ruler 20 from sliding out of the bracket 10.

In one embodiment, the scale value N is 100 mm, allowing users to view and easily decipher values up and down the scale.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A measuring device, comprising:
a bracket comprising a base and a first side plate on the base; and
a sliding ruler slidably attached to the bracket and comprising a top wall and a first sidewall extending from the top wall;
wherein the first side plate comprises a first top surface, a first set of scale lines, and first scale values marking the first set of scale lines; the first scale values increase incrementally from the base to a scale value N at the first top surface; and a distance between the first top surface and a bottom surface of the base is equal to the scale value N; the first sidewall comprises second set of scale lines, and second scale values marking the second set of scale lines; the second scale values decrease incrementally from the base to the scale value N at the top wall.

2. The measuring device of claim 1, wherein the scale value N is 100 mm.

3. The measuring device of claim 1, wherein the bracket further comprises a second side plate being substantially perpendicular to the first side plate and the base; the second side plate comprises a second top surface being coplanar with the first top surface; and the second side plate comprises a third set of scale lines.

4. The measuring device of claim 3, wherein the third set of scale lines comprises third scale values, and the third scale values increase incrementally from the second top surface to the base.

5. The measuring device of claim 1, wherein the sliding ruler further comprises a rear wall, a first sidewall, a second sidewall, and a front wall opposite to the rear wall; the first sidewall is substantially parallel to the second sidewall, and the first sidewall is substantially perpendicular to the front wall; the rear wall abuts the first side plate and defines a sliding slot.

6. The measuring device of claim 5, further comprising a limiting member, wherein the limiting member comprises a limiting portion and a blocking portion connected to the limiting portion; the second sidewall abuts the second side plate; the front wall defines an opening; the first side plate defines an installation hole, and the limiting portion is engaged in the installation hole through the sliding slot.

7. The measuring device of claim 6, wherein the sliding slot comprise a limiting end, and the limiting end abuts the limiting portion when the sliding ruler is slid relative to the bracket thereby preventing the sliding ruler from sliding out of the bracket.

8. The measuring device of claim 6, further comprising a mounting member, wherein the mounting member comprises a locking portion, a first mounting portion, and a second mounting portion; a cross-section of each of the locking portion, the first mounting portion, and the second mounting portion is circular; a diameter of the locking portion is greater than a diameter of the first mounting portion, and the diameter of the first mounting portion is greater than a diameter of the second mounting portion; the first side plate defines a locking hole, and the locking portion is engaged in the locking hole through the opening and the sliding slot.

9. The measuring device of claim 8, wherein the diameter of the locking portion is smaller than a width of the sliding slot; the first mounting portion abuts the rear wall; and
the diameter of the first mounting portion is greater than a width of the opening.

10. The measuring device of claim 8, wherein the second mounting portion abuts the front wall, and the diameter of the second mounting portion is greater than the width of the opening.

11. A measuring device, comprising:
a bracket comprising a base and a first side plate on the base; and the first side plate defining an installation hole and a locking hole;
a sliding ruler slidably attached to the bracket and comprising a top wall, a rear wall, and a first sidewall, the rear wall and the first sidewall being substantially perpendicularly extending from the top wall; and the rear wall defining a sliding slot;
a limiting member engaged with the installation hole through the sliding slot; and
a mounting member engaged in the locking hole through installation hole to secure the sliding ruler to the bracket when the sliding ruler is positioned in a desired position;
wherein the first side plate comprises a first top surface and a first set of scale lines, and first scale values marking the first set of scale lines; and the first scale values increase incrementally from the base to a scale value N at the first top surface; and a distance between the first top surface and a bottom surface of the base is equal to the scale value N; the first sidewall comprises second set of scale lines, and second scale values marking the second set of scale lines; and the second scale values decrease incrementally from the base to the scale value N at the top wall.

12. The measuring device of claim 11, wherein the scale value N is 100 mm.

13. The measuring device of claim 11, wherein the bracket further comprises a second side plate being substantially perpendicular to the first side plate and the base; the second side plate comprises a second top surface being coplanar with the first top surface; and the second side plate comprises a third set of scale lines.

14. The measuring device of claim 13, wherein the third set of scale lines comprises third scale values, and the third scale values increase incrementally from the second top surface to the base.

15. The measuring device of claim 11, wherein the sliding ruler further comprises a first sidewall, a second sidewall, and a front wall opposite to the rear wall; the first sidewall is substantially parallel to the second sidewall, and the first sidewall is substantially perpendicular to the front wall; and the rear wall abuts the first side plate.

16. The measuring device of claim 15, wherein the limiting member comprises a limiting portion and a blocking portion connected to the limiting portion; the second sidewall abuts the second side plate; the front wall defines an opening; and the limiting portion is engaged in the installation hole through the sliding slot.

17. The measuring device of claim 16, wherein the sliding slot comprise a limiting end, and the limiting end abuts the limiting portion when the sliding ruler is slid relative to the bracket thereby preventing the sliding ruler from sliding out of the bracket.

18. The measuring device of claim 16, wherein the mounting member comprises a locking portion, a first mounting portion, and a second mounting portion; a cross-section of each of the locking portion, the first mounting portion, and the second mounting portion is circular; a diameter of the locking portion is greater than a diameter of the first mounting portion, and the diameter of the first mounting portion is greater than a diameter of the second mounting portion; and the locking portion is engaged in the locking hole through the opening and the sliding slot.

19. The measuring device of claim 18, wherein the diameter of the locking portion is smaller than a width of the sliding slot; the first mounting portion abuts the rear wall; and the diameter of the first mounting portion is greater than a width of the opening.

20. The measuring device of claim 18, wherein the second mounting portion abuts the front wall, and the diameter of the second mounting portion is greater than the width of the opening.
